(19) United States
(12) Patent Application Publication
(10) Pub. No.: US 2006/0214845 A1
(43) Pub. Date: Sep. 28, 2006

(54) Global positioning system (GPS) accessories, hosts and methods that use radio frequency transmission of raw GPS data

(76) Inventors: Magnus Jendbro, Staffanstorp (SE); Robert Westholm, Lund (SE)

Correspondence Address: MYERS BIGEL SIBLEY & SAJOVEC, P.A., P.O. BOX 37428, RALEIGH, NC, 27627, US

(21) Appl. No.: 11/087,534

(22) Filed: Mar. 23, 2005

(51) Int. Cl. G01S 5/14

(52) U.S. Cl. 342/357.09

(57) ABSTRACT

GPS accessories for host devices include a GPS Radio Frequency (RF) receiver that receives GPS signals over a GPS radio frequency and obtains raw GPS data from the GPS signals. A wireless RF transmitter wirelessly transmits the raw GPS data to a host device over a non-GPS radio frequency. The wireless RF transmitter may include an ad hoc short range wireless network transmitter, such as a Bluetooth transmitter.

### TECHNICAL FIELD OF THE INVENTION

This invention relates to wireless communications systems, methods and devices, and more particularly to Global Positioning System (GPS) communications systems, methods and devices.

### DESCRIPTION OF RELATED ART

Wireless position measuring systems, methods and devices are being widely used in many consumer, commercial and other applications. As is well known to those having skill in the art, GPS is a satellite navigation system that is funded by and controlled by the U.S. Department of Defense, that provides specially coded satellite signals that can be processed in a GPS receiver, enabling the receiver to compute position, velocity and/or time. As used herein, the term “GPS” also includes other satellite-based systems that can be used to measure positions on the earth, such as GLONASS and Galileo.

GPS receivers may be integrated into a mobile terminal. See, for example, U.S. Pat. No. 6,424,826 to Horton et al., entitled Systems and Methods for Sharing Reference Frequency Signals Within a Wireless Mobile Terminal Between a Wireless Transceiver and a Global Positioning System Receiver; and U.S. Pat. No. 6,097,974 to Camp, Jr. et al., entitled Combined GPS and Wide Bandwidth Radiotelephone Terminals and Methods.

It is also known to provide separate GPS receivers that can determine a position from GPS data and wirelessly relay this position to another device. For example, as described in the abstract of U.S. Pat. No. 6,836,645 to Hilgers et al., entitled GPS Receiver Module, a GPS receiver module for receiving GPS signals and for determining position data therefrom is characterized by a communications sub-module, to which the position data determined can be fed and by means of which said data can be converted into a format suitable for transmission to an external appliance. The communications sub-module is preferably a Bluetooth sub-module, by means of which the position data can be converted according to the Bluetooth standard and transmitted by wireless means. A dual band antenna particularly suitable for use with the GPS receiver module is furthermore described, by means of which it is not only possible to receive GPS signals, but also to establish a communications link with external appliances.

As is well known to those having skill in the art, Bluetooth is a global standard that can eliminate wires and cables between both stationary and mobile devices, can facilitate both data and voice communication, and can provide ad hoc networks that can be set up automatically and provide synchronicity between network devices. Bluetooth is described in detail at Bluetooth.com.

It is also known to provide “Bluetooth GPS” receivers that can receive GPS signals, compute position data from the GPS signals and send the position data to an external device, such as a wireless terminal, via a Bluetooth interface. See, for example, MightyGPS.com/bluetoothgps.

As used herein, the term “wireless terminal” includes cellular and/or satellite radiotelephones with or without a multi-line display; Personal Communications System (PCS) terminals that may combine a radiotelephone with data processing, facsimile and/or data communications capabilities; Personal Digital Assistants (PDA) that can include a radio frequency transceiver and a pager, Internet/intranet access, Web browser, organizer, calendar and/or conventional laptop and/or palmtop computers or other appliances, which include a radio frequency transceiver. Wireless terminals may also be referred to herein as radioterminals or simply as terminals.

### SUMMARY

GPS accessories for host devices according to various embodiments of the present invention include a GPS Radio Frequency (RF) receiver that is configured to receive GPS signals over a GPS radio frequency, and to obtain raw GPS data therefrom. As used herein, “raw GPS data” includes pseudorange, integrated carrier phase, Doppler Shift and/or satellite ephemeris data that are extracted from the GPS signals. A wireless RF transmitter is responsive to the GPS RF receiver, and is configured to wirelessly transmit the raw GPS data to a host device over a non-GPS radio frequency.

In some embodiments, the GPS RF receiver is configured to downconvert the GPS signals to baseband signals. In some embodiments, the wireless RF transmitter includes an ad hoc short range wireless network transmitter, such as a Bluetooth transmitter. In other embodiments, the GPS RF receiver comprises a GPS RF chip (integrated circuit), and the wireless RF transmitter comprises a Bluetooth chip.

GPS-enabled host devices according to various embodiments of the present invention include a wireless RF receiver that is configured to receive raw GPS data over a non-GPS radio frequency, a GPS processor that is configured to compute position data from the raw GPS data and an interface processor that is configured to utilize the position data to perform host device functions. As used herein, the term “GPS processor” includes an Assisted GPS (A-GPS) processor that computes the position data from the raw GPS data and assistance data that may be provided via another communications link. As used herein, “position data” includes velocity and time data. The wireless RF receiver can comprise an ad hoc short range wireless network receiver.

In some embodiments, the GPS processor is included in a digital signal processor that is contained in the host. For example, the digital signal processor can execute GPS software to perform GPS processing. The interface processor may include a display that is configured to display the position data. In some embodiments, the ad hoc short range wireless network receiver comprises a Bluetooth receiver. Moreover, in some embodiments, the GPS-enabled host device is a wireless terminal.

It will be understood that embodiments of the present invention have been described above primarily with respect to GPS accessories for host devices and GPS-enabled host devices. However, analogous GPS signal processing method embodiments also may be provided.

### BRIEF DESCRIPTION OF THE DRAWINGS

FIG. 1 is a block diagram of a conventional GPS device.

FIGS. 2-3 are block diagrams of GPS accessories, host devices and related methods according to various embodiments of the present invention.

FIG. 4 is a schematic diagram of a GPS accessory, host device and related methods according to other embodiments of the present invention.

FIG. 5 is a block diagram of a GPS accessory and related methods according to still other embodiments of the present invention.

FIG. 6 is a flowchart of operations that may be performed by a GPS accessory according to various embodiments of the present invention.

FIG. 7 is a flowchart of operations that may be performed by a host device according to various embodiments of the present invention.

### DETAILED DESCRIPTION OF EMBODIMENTS

Specific exemplary embodiments of the invention now will be described with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawing, like numbers refer to like elements. It will be understood that when an element is referred to as being “connected” or “coupled” to another element, it can be directly connected or coupled to the other element or intervening elements may be present. Furthermore, “connected” or “coupled” as used herein may include wirelessly connected or coupled.

The terminology used herein is for the purpose of describing particular embodiments only and is not intended to be limiting of the invention. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that although the terms first and second are used herein to describe various elements, these elements should not be limited by these terms. These terms are only used to distinguish one element from another element. Thus, a first antenna below could be termed a second antenna, and similarly, a second antenna may be termed a first antenna without departing from the teachings of the present invention. As used herein, the term “and/or” includes any and all combinations of one or more of the associated listed items. The symbol “/” is also used as a shorthand notation for “and/or”.

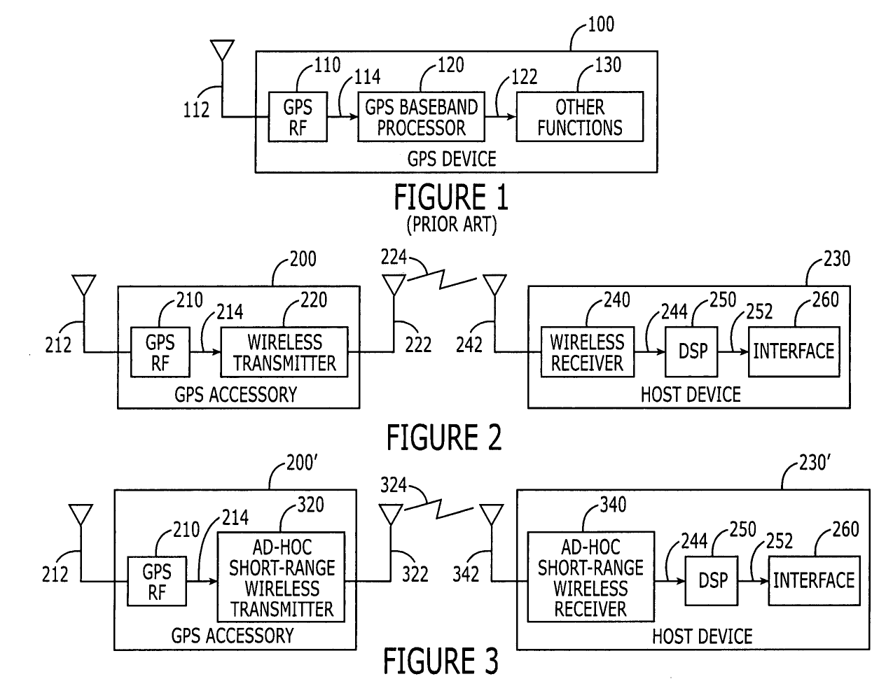

FIG. 1 is a block diagram of conventional GPS devices 100. As shown in FIG. 1, a conventional GPS device 100 includes a GPS RF receiver 110, which may be embodied in a single GPS radio chip, and which is configured to receive, via an antenna 112, a GPS signal at a GPS radio frequency of 1575.42 MHz. As is well known to those having skill in the art, the GPS signal generally includes a pseudorandom code, ephemeris data, almanac data and/or other data. The GPS RF receiver 110 demodulates the GPS signals to obtain raw GPS data 114 therefrom. The raw GPS data 114 is provided to a GPS baseband processor 120 for processing, to compute position data 122. The GPS baseband processor 120 performs various computationally intensive calculations, generally including correlations. As is well known to those having skill in the art, the GPS baseband processor 120 may be a dedicated GPS baseband processor or may be a digital signal processor that executes GPS software, to thereby compute the position data 122 from the raw GPS data 114. The raw GPS data 114 is generally provided from the GPS RF receiver 110 to the GPS baseband processor 120 over a high speed serial bus. Finally, other functions 130, such as a user interface including a display also may be provided, based on the position data 122.

Some embodiments of the present invention may arise from a recognition that wireless GPS receivers generally include a relatively expensive GPS baseband processor or digital signal processor. Yet, these wireless GPS receivers may then relay the GPS position data to a host device, such as a wireless terminal, which itself already generally includes a digital signal processor or other high capability processor. Embodiments of the present invention can provide GPS accessories and methods that receive GPS signals at a GPS radio frequency and obtain raw GPS data therefrom, and then wirelessly transmit the raw GPS data to a host device, such as a wireless terminal, over a non-GPS radio frequency. The host device, such as a wireless terminal, can receive the raw GPS data over the non-GPS radio frequency, and can compute position data from the raw GPS data using a GPS processor, such as a digital signal processor that executes GPS software, in the host device. By relieving the GPS accessory of the need to compute the position data from the raw GPS data, the GPS accessory may be relatively simple, small, inexpensive and/or low power compared to GPS receivers with onboard GPS baseband processing.

FIG. 2 is a block diagram of GPS accessories, host devices and related methods according to various embodiments of the present invention. As shown in FIG. 2, a GPS accessory 200 according to some embodiments of the present invention includes a GPS RF receiver 210 that is configured to receive GPS signals at a GPS radio frequency, for example from a GPS antenna 212, and to obtain raw GPS data 214 therefrom. The raw GPS data 214 may be provided at baseband and/or may be downconverted to an intermediate frequency from the GPS frequency of 1575.42 MHz. A wireless radio frequency transmitter 220 is responsive to the GPS RF receiver 210, and is configured to wirelessly transmit 224 the raw GPS data 214 to a host device 230 over a non-GPS radio frequency, for example via a transmitting antenna 222. It will be understood by those having skill in the art that the functionality of the GPS antenna 212 and the transmitting antenna 222 may be merged, at least in part, or two separate antennas may be provided, as shown in FIG. 2. In some embodiments, the GPS RF receiver 210 is configured to digitize the baseband signals whereas, in other embodiments, the GPS RF receiver 210 provides the raw GPS data 214 in analog form.

Still referring to FIG. 2, the host device 230, which may be a wireless terminal in some embodiments of the present invention, includes a wireless RF receiver 240 that is configured to receive the raw GPS data 214 over a non-GPS radio frequency, for example via an antenna 242. A GPS processor is also included in the host device 230 that is configured to compute position data 252 from the raw GPS data 244 that is output from the wireless RF receiver 240. In some embodiments, the GPS processor is a special purpose GPS processor. However, in other embodiments, the GPS processor is contained within a digital signal processor (DSP) 250 by executing GPS software that is configured to compute the position data 252 from the raw GPS data 244. An interface processor 260 is configured to utilize the position data 252 to perform host device functions such as to display the position data on a display, to provide voice synthesized instructions and/or other common user interface and/or machine interface functions. It also will be understood that the antenna 242, wireless receiver 240, digital signal processor 250 and/or interface 260 may be merged, at least in part, with similar functionality, such as antennas, receivers, processors and/or interfaces, in the host device 230.

FIG. 3 is a block diagram of GPS accessories 200′, host devices 230′ and related methods according to other embodiments of the present invention. In these embodiments, the GPS accessory 200′ uses an ad hoc short range wireless transmitter 320 as a wireless transmitter 220, and the host device 230′ uses an ad hoc short range wireless receiver 340 as a wireless receiver 240. One widely used ad hoc short range wireless transmitter and receiver system utilizes the Bluetooth standard, which uses a frequency range between approximately 2400 MHz and 2483.5 MHz, so that, in some embodiments, the antennas 322 and 342 are configured to operate over these frequencies. In some embodiments, a conventional low speed Bluetooth link 324 may be used to transmit and receive the raw GPS data. In other embodiments, a high speed Bluetooth link, such as is described in the Bluetooth Core Specification V2.0+EDR may be used. In other embodiments, other ad hoc short range networks, such as Wi-Fi (IEEE 802.11a, 802.11b) may be used. In still other embodiments, other wireless networks, such as Virtual Local Area Networks (VLAN) (IEEE 802.IQ) may be used.

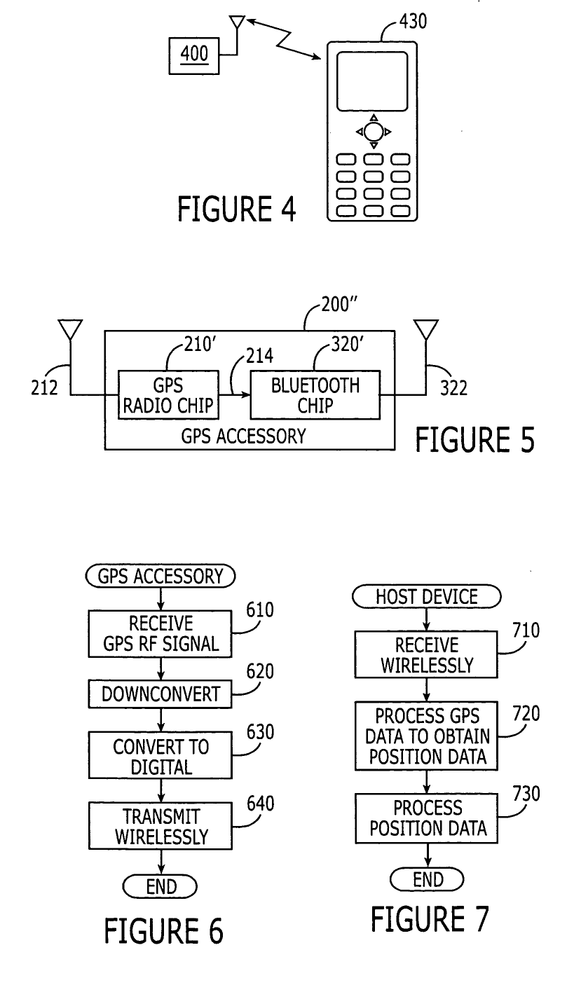

FIG. 4 is a schematic diagram of other embodiments of the present invention. In these embodiments, a GPS accessory 400 may be embodied as was described in FIG. 2 or 3. The GPS accessory 400 may be lower cost, smaller, less complex and/or lower power compared to conventional GPS devices, because complex digital signal processing need not be performed in the GPS accessory 400. Moreover, the host device 430 may be embodied as a conventional wireless terminal, which includes its own hardware and/or software GPS processor. As was described in connection with FIG. 3, in some embodiments, the host device 430 may include a digital signal processor that runs GPS software.

FIG. 5 is a block diagram of GPS accessories according to yet other embodiments of the present invention. As shown in FIG. 5, these embodiments of GPS accessories 200″ include a GPS radio chip 210′ that can operate as a GPS RF receiver 210, and a Bluetooth chip 320′ that can provide an ad hoc short range wireless transmitter 320 or a wireless transmitter 220.

FIG. 6 is a flowchart of operations that may performed by a GPS accessory, such as a GPS accessory 200 of FIG. 2, 200′ of FIG. 3, 400 of FIG. 4 and/or 200″ of FIG. 5, according to various embodiments of the present invention. As shown in FIG. 6, the GPS accessory receives a GPS RF signal at Block 610, for example via a GPS receiving antenna 212. The GPS RF signal is then downconverted to an intermediate frequency and/or to baseband at Block 620, to obtain the raw GPS data. At Block 630, the downconverted signal is converted from analog to digital, and at Block 640, the signal is transmitted wirelessly, for example using the transmitter 220 of FIG. 2, 320 of FIG. 3 and/or 320′ of FIG. 5. It will be understood that, in other embodiments, conversion to digital (Block 630) need not take place and the raw GPS data may be transmitted in the analog domain.

FIG. 7 is a flowchart of operations that may be performed by a host device, such as a host device 230 of FIG. 2, 230′ of FIG. 3 and/or 430 of FIG. 4, according to various embodiments of the present invention. As shown in FIG. 7 at Block 710, the raw GPS data is received wirelessly, for example using the wireless receiver 240 of FIG. 2 and/or the short range wireless receiver 340 of FIG. 3. Then, at Block 270, the GPS data is processed, for example by the digital signal processor 250 of FIGS. 2 and/or 3 and/or the digital signal processor in the wireless terminal 430 of FIG. 4, to obtain position data. At Block 730, the position data is processed, for example by the interface 260 of FIG. 2 or 3.

Additional discussion of various embodiments of the present invention now will be described. In particular, software GPS is conventionally implemented by connecting a GPS radio chip (which may include an analog-to-digital converter) to the device baseband. In software GPS, the device baseband performs calculations that are normally made by a separate hardware GPS baseband system in a conventional GPS receiver. A GPS receiver in a software GPS implementation is generally connected to the device baseband by a high speed serial bus.

Small external devices such as wireless terminal accessories normally may include a very limited capability microcontroller. It may difficult for this microcontroller to perform software GPS-related calculations efficiently or in a timely manner. Moreover, if one wished to provide software GPS in an external device, it may require the placement of an expensive processor and/or digital signal processor in the external device.

In contrast, embodiments of the present invention can partition a GPS system or method such that the GPS receiver resides in the external device, for example, in a wireless terminal accessory. Since the external device may not have enough computation power to perform the extensive calculations that may be needed in a software GPS system, embodiments of the present invention transmit the raw data stream from the software GPS radio to be transmitted over another RF link, such as a high speed Bluetooth link, to a host, such as a wireless terminal (e.g., a mobile phone). The host baseband will generally have enough computation power to perform the software GPS calculations using the raw GPS data sent from the external device.

Thus, if the raw GPS RF data can be transmitted (for example, streamed) from the external device to a mobile phone, there may be no need for heavy calculations in the external device and a powerful processor may not be needed. This can reduce the size, power consumption and/or cost of the external device.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A Global Positioning System (GPS) accessory for a host device comprising:
a GPS Radio Frequency (RF) receiver that is configured to receive GPS signals over a GPS radio frequency and to obtain raw GPS data therefrom; and
a wireless RF transmitter that is responsive to the GPS RF receiver and is configured to wirelessly transmit the raw GPS data to a host device over a non-GPS radio frequency.

2. A GPS accessory according to claim 1 wherein the GPS RF receiver is configured to downconvert the GPS signals to baseband signals.

3. A GPS accessory according to claim 1 wherein the wireless RF transmitter comprises an ad hoc short range wireless network transmitter.

4. A GPS accessory according to claim 3 wherein the ad hoc short range wireless network transmitter comprises a Bluetooth, IEEE 802.11 and/or IEEE 802.IQ transmitter.

5. A GPS accessory according to claim 1 wherein the GPS RF receiver comprises a GPS RF chip and wherein the wireless RF transmitter comprises a Bluetooth chip.

6. A Global Positioning System (GPS) enabled host device comprising:
a wireless Radio Frequency (RF) receiver that is configured to receive raw GPS data over a non-GPS radio frequency;
a GPS processor that is configured to compute position data from the raw GPS data; and
an interface processor that is configured to utilize the position data to perform host device functions.

7. A GPS enabled host device according to claim 6 wherein the wireless RF receiver comprises an ad hoc short range wireless network receiver.

8. A GPS enabled host device according to claim 6 further comprising a digital signal processor, wherein the GPS processor is included in the digital signal processor.

9. A GPS enabled host device according to claim 6 wherein the interface processor includes a display that is configured to display the position data.

10. A GPS enabled host device according to claim 7 wherein the ad hoc short range wireless network receiver comprises a Bluetooth, IEEE 802.11 and/or IEEE 802.IQ receiver.

11. A GPS enabled host device according to claim 6 wherein the GPS enabled host device is a wireless terminal, such as a mobile phone.

12. A Global Positioning System (GPS) signal processing method comprising:
receiving GPS signals over a GPS radio frequency and obtaining raw GPS data therefrom; and
wirelessly transmitting the raw GPS data to a host device over a non-GPS radio frequency.

13. A method according to claim 12 wherein wirelessly transmitting the raw GPS data to a host device comprises wirelessly transmitting the raw GPS data to a host device over an ad hoc short range wireless network.

14. A method according to claim 13 wherein the ad hoc short range wireless network comprises a Bluetooth, IEEE 802.11 and/or IEEE 802.IQ network.

15. A Global Positioning System (GPS) signal processing method comprising:
receiving raw GPS data over a non-GPS radio frequency;
computing position data from the raw GPS data; and
utilizing the position data to perform host device functions.

16. A method according to claim 15 wherein receiving raw GPS data over a non-GPS radio frequency comprises receiving raw GPS data over an ad hoc short range wireless network.

17. A method according to claim 15 wherein computing position data from the raw GPS data is performed by executing GPS software in a digital signal processor.

18. A method according to claim 15 wherein utilizing the position data to perform host device functions comprises displaying the position data.

19. A method according to claim 16 wherein the ad hoc short range wireless network comprises a Bluetooth, IEEE 802.11 and/or IEEE 802.IQ network.

20. A method according to claim 15 wherein the GPS signal processing method is performed in a wireless terminal, such as a mobile phone.
